(19) United States
(12) Patent Application Publication
(10) Pub. No.: US 2026/0168777 A1
(43) Pub. Date: Jun. 18, 2026

(54) TAPE MEASURE

(71) Applicant: ScopeAround, Irvine, CA (US)

(72) Inventor: Yingjie SUN, Irvine, CA (US)

(73) Assignee: ScopeAround, Irvine, CA (US)

(21) Appl. No.: 19/019,638

(22) Filed: Jan. 14, 2025

(30) Foreign Application Priority Data
Dec. 16, 2024 (CN) 202423111329.3

(51) Int. Cl. G01B 3/1071; G01B 3/1043; G01B 3/1048

(52) U.S. Cl. CPC G01B 3/1071; G01B 3/1043; G01B 3/1048; G01B 2003/1074; G01B 2003/1076

(57) ABSTRACT

A tape measure includes a case, a measuring tape, and a snap-fit assembly. An opening is arranged on the case. The measuring tape is capable of be pulled out of the case or retract into the case through the opening. A first fastener is fixedly connected to a second end of the measuring tape. The first fastener is capable of selectively and magnetically engage with one of second fasteners. The first fastener and the second fasteners limit the position of the first fastener on the case through a limiting structure. The snap-fit assembly is capable of reduce the occurrence of accidental detachment of the first fastener from the case.

### CROSS-REFERENCE TO RELATED APPLICATIONS

The application claims priority to Chinese patent application No. 202423111329.3, filed on Dec. 16, 2024, the entire contents of which are incorporated herein by reference.

### TECHNICAL FIELD

The embodiments of the present application relate to a tape measure.

### BACKGROUND

A tape measure is a versatile tool used for measuring lengths. The tape measure can serve to measure straight or curve lines, such as the length of an object and its circumference. To measure the circumference of the object, a measuring tape needs to be wrapped around the object once. However, in the related art, an end of the measuring tape needs to be held to prevent the measuring tape from automatically retracting. In addition, when measuring the circumference, the end of the measuring tape wrapped around the object once should be as close to the measuring tape as possible to ensure accuracy. However, the small angle between the tape measure and the object results in a relatively limited space for operation, making measurement difficult.

### SUMMARY

The embodiments of the present application provide a tape measure for solving at least one technical problem in the related art.

A tape measure comprising a case and a measuring tape, wherein an opening is arranged on the case, the measuring tape is capable of be pulled out of the case or retract into the case through the opening, the measuring tape has a first end that is limited to an inner side of the case, and a second end that is limited to an outer side of the case, further comprising a snap-fit assembly, wherein the snap-fit assembly comprises a first fastener and at least one second fastener, the first fastener is fixedly connected to the second end of the measuring tape, the second fastener is arranged on the case, at least one of the first fastener and the second fastener has magnetism, and the first fastener is capable of selectively and magnetically engage with one of the second fasteners, so that the first fastener is adsorbed on the case.

In some embodiments, the second fastener comprises a panel, which has one end that is arranged at an edge of the opening, and the first fastener is adsorbed onto the panel and fit to the panel when the first fastener engages with the second fastener.

In some embodiments, the second fastener comprises a magnetic sheet, which is arranged on one side of the panel, which side faces interior of the case.

In some embodiments, an accommodating cavity is arranged on one side of the panel, which side faces the interior of the case, and the magnetic sheet is arranged within the cavity.

In some embodiments, the panel is provided with an accommodating slot that sinks toward the interior of the case, and the magnetic sheet is scarfed in the accommodating slot.

In some embodiments, a first limiting member is arranged on one side of the first fastener, which side faces the second fastener, a second limiting member is arranged on the panel, and the first limiting member and the second limiting member is capable of selectively fit in with each other to define the position of the first fastener on the panel.

In some embodiments, the first limiting member comprises a limiting block that protrudes outward, and the second limiting member comprises a limiting slot that sinks inward.

In some embodiments, the first limiting member comprises a limiting slot that sinks inward, and the second limiting member comprises a limiting block that protrudes outward.

In some embodiments, a first fastening member is arranged on one side of the first fastener, which side faces the second fastener, a second fastening member is arranged on the panel, and the first fastening member and the second fastening member is capable of selectively fit in with each other by fastening, to limit the detachment of the first fastener from the panel under the pull of the measuring tape.

In some embodiments, the first fastening member comprises an snap-fit that protrudes outward, and the second fastening member comprises a snap-fit slot that sinks inward; the snap-fit comprises a hook portion that is opened toward the measuring tape, and the snap-fit slot comprises a hook slot portion that extends toward the opening; after the snap-fit is engaged with the snap-fit slot, the hook portion of the snap-fit fits in with the hook slot portion of the snap-fit slot by fastening.

In some embodiments, the first fastening member comprises a snap-fit slot that sinks inward, and the second fastening member comprises an snap-fit that protrudes outward; the snap-fit slot comprises a hook slot portion that extends away from the measuring tape, and the snap-fit comprises a hook portion that is opened away from the opening; after the snap-fit is engaged with the snap-fit slot, the hook portion of the snap-fit and the hook slot portion of the snap-fit slot fit in with each other.

In some embodiments, the snap-fit slot is provided with a slope surface, the slope surface and the hook slot portion are arranged at opposite ends of the snap-fit slot, the slope surface extends along a slot opening of the snap-fit slot toward both interior of the snap-fit slot and the hook slot portion;

the snap-fit is provided with a guide surface, the guide surface and the hook portion are arranged at opposite ends of the snap-fit, and the guide surface shares a slope gradient with the slope surface.

In some embodiments, the surface of the panel is provided with a patch, which is configured to:

provide buffering when the first fastener is absorbed on the panel; or/and emit light to indicate the position of the panel.

Compared with the related art, the present application discloses a tape measure, which has a measuring tape, with a free end that is capable of be absorbed on the case of the tape measure. When measuring the circumference of an object to be measured, there is no need to hold the free end of the measuring tape, which provides convenience for measurement. Specifically, the embodiments of the present application disclose a snap-fit assembly, which comprises a first fastener and a second fastener. The first fastener is fixedly connected to the free end of the measuring tape, and the second fastener is arranged on the case of the tape measure. At least one of the first fastener and the second fastener comprises one permanent magnet. The first fastener is capable of be selectively absorbed on the case under the action of a magnetic attraction force. In addition, the first fastener and the second fastener define the position of the first fastener on the case through a limiting structure, which reduces the time required for correcting the position and improves the measurement efficiency. In addition, the first fastener and the second fastener are further provided with fastening assemblies, which is capable of reduce the occurrence of accidental detachment of the first fastener from the case when measuring the circumference. Fourthly, the first fastener is capable of be absorbed on the case, which reduces the requirement for the operating space.

### BRIEF DESCRIPTION OF DRAWINGS

The figures of the description, which constitute a part of the present application, serve to provide further understanding of the present application. The illustrative embodiments and explanations thereof in the present application serve to make clear the present application, and do not constitute undue limitations upon the present application. Wherein:

FIG. 1 is a structure view of a tape measure in accordance with the embodiments of the present application.

FIG. 2 is a view of FIG. 1 from one of perspectives.

FIG. 3 is a partial, exploded view of a tape measure in accordance with the embodiments of the present application.

FIG. 4 is a partial enlarged view of Area B in FIG. 3 in accordance with embodiments of the present application.

FIG. 5 is a partial enlarged view of Area B in FIG. 3 in accordance with the embodiments of the present application.

FIG. 6 is a view of FIG. 1 from one of perspectives.

FIG. 7 is a cutaway view of FIG. 6 along the direction CC.

FIG. 8 is a partial enlarged view of Area A in FIG. 1 in accordance with the embodiments of the present application.

FIG. 9 is a partial enlarged view of Area D in FIG. 7.

FIG. 10 is another view of FIG. 9.

FIGS. 11 and 12 are views of measuring the circumference of an object.

FIG. 13 is a partial enlarged view of Area A in FIG. 1 in accordance with the embodiments of the present application

FIG. 14 is a partial enlarged view of Area D in FIG. 7.

FIG. 15 is another view of FIG. 14;

FIG. 16 is a view of partially scarfing an snap-fit and a snap-fit slot together in accordance with embodiments of the present application.

FIG. 17 is a structure view of a chamfering table and an inclined surface in accordance with the embodiments of the present application.

Reference signs in the drawings: 10. case; 101. first side wall 101; 102. second side wall; 11. first case body; 12. second case body; 121. storage compartment; 122. opening; 1231. accommodating cavity; 1232. accommodating slot; 124. groove; 125. guide post; 126. guide roller; 20. measuring tape; 30. snap-fit assembly; 31. first fastener; 311 limiting block; 312. snap-fit; 3121. hook portion; 3122. guide surface; 313. chamfering table; 3131. chamfered surface; 314. tape opening; 32/32a/32b. second fastener; 321. magnetic sheet; 322. limiting slot; 323. patch; 3231. through hole; 324. snap-fit slot; 3241. hook slot portion; 3242. slope surface; 325. panel; 3251. inclined surface; 40. coil spring; 50. winding shaft; 51. rotating shaft; 60. braking structure; 61. roller shaft; 62. brake shaft; 200. object to be measured.

### DETAILED DESCRIPTION OF THE EMBODIMENTS

The present application will be elaborated below with reference to the drawings and in combination with the embodiments. Each example is provided to explain the present application, rather than limit the present application. In fact, those skilled in the art will understand that modifications and transformations is capable of be made in the present application without departing from the scope or spirit of the present application. For example, features shown or described as part of one embodiment is capable of be used in another embodiment to generate one more embodiment. Therefore, it is expected that the present application includes such modifications and transformations that fall within the scope of the attached claims and equivalents thereof.

In the description of the present application, the orientation or positional relationship indicated by terms such as “vertical”, “horizontal”, “up”, “down”, “front”, “back”, “left”, “right”, “vertical”, “horizontal”, “top”, and “bottom” orientation or positional relationship shown on the basis of the drawings. They only serve the purpose of facilitating the illustration of the present application, and do not require that the present application must relate to constructing and operating in a specific orientation. Therefore, they cannot be understood as limitations upon the present application. The terms “connect”, “link”, and “arrange” used in the present application should be broadly understood. For example, they is capable of be fixed connection or detachable connection; they is capable of be direct connection or indirect connection through an intermediate component. Those skilled in the art is capable of understand the specific meanings of the above terms according to specific situations.

One or more examples of the present application are shown in the attached drawings. In the detailed description, numerical and alphabetical signs are used to refer to the features in the drawings. Same or similar signs in the drawings and description have been used to refer to same or similar parts in the present application. As used in this text, the terms “first”, “second”, and “third” are interchangeable to distinguish one component from another, and are not intended to indicate the position or importance of individual components.

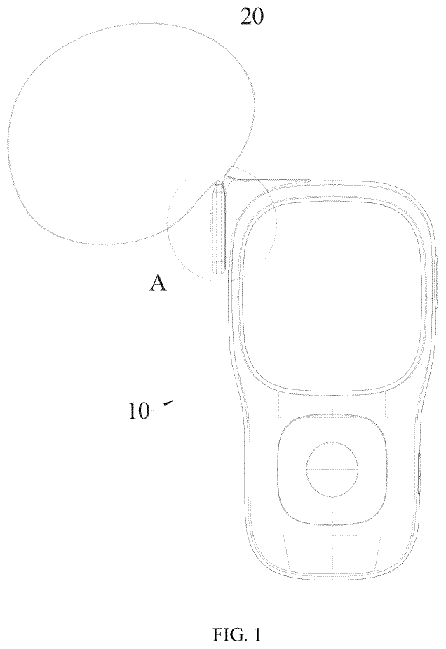

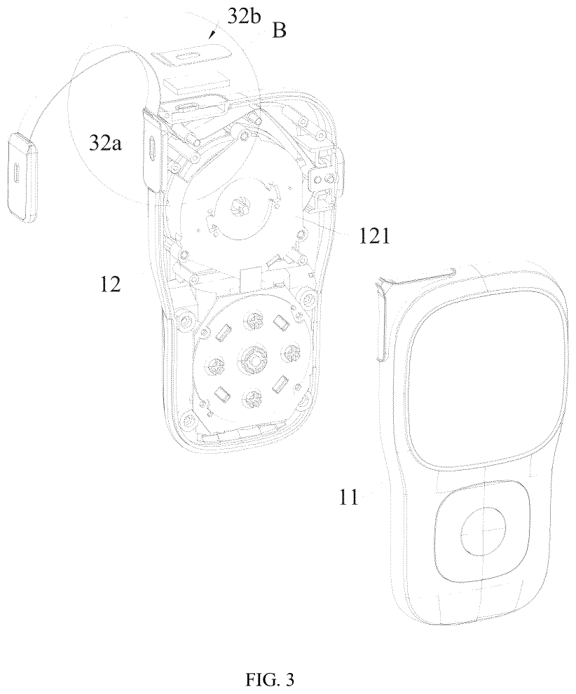

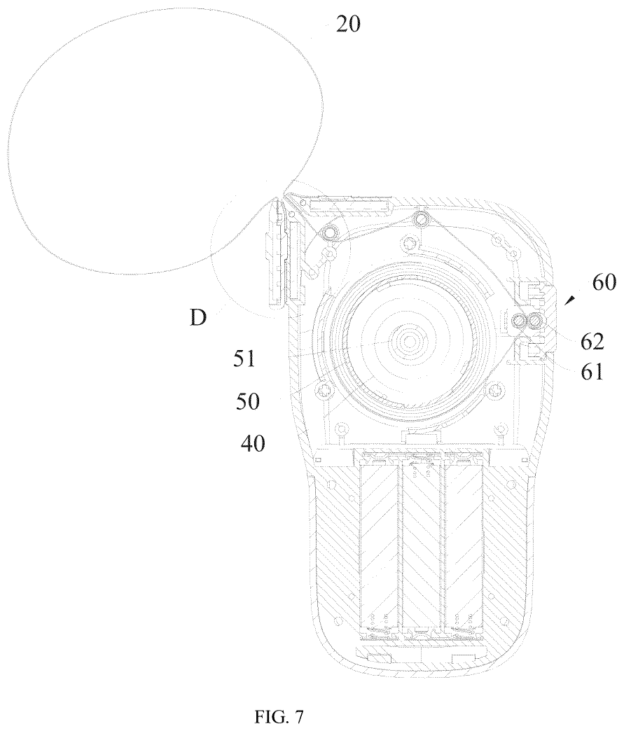

As shown in FIG. 1, FIG. 3, and FIG. 7, according to the embodiments of the present application, there is a provided a tape measure, which comprises a case 10; an opening 122 is arranged on the case 10; a measuring tape 20 is arranged inside the case 10; the measuring tape 20 is capable of be pulled out of the case 10 or retract into the case 10 through the opening 122. The case 10 comprises a first case 11 and a second case 12, and the measuring tape 20 is placed between the first case 11 and the second case 12. A storage compartment 121 is arranged inside the second case 12, and at least a portion of the measuring tape 20 is confined within the storage compartment 121.

As shown in FIG. 7, in some embodiments, a winding shaft 50 is arranged inside the storage compartment 121, and a first end of the measuring tape 20 is connected to a rotating shaft 51 and wound around an outer side of the winding shaft 50. The winding shaft 50 is circular, and is provided with the rotating shaft 51 and rotatably connected to the rotating shaft 51. One end of the rotating shaft 51 is fixedly connected to the second case 12. The rotating shaft 51 is in sleeve connection with a spiral spring 40, which has one end in connection with the rotating shaft 51 and the other end in connection with the winding shaft 50. The measuring tape 20 is pulled outward and drives the winding shaft 50 to rotate, so that the coil spring 40 accumulates energy; after the external force for pulling the measuring tape 20 is removed, the coil spring 40 releases the energy to drive the winding shaft 50 to rotate in the opposite direction, re-winding the measuring tape 20 around the winding shaft 50. A braking structure 60 is mounted on the case 10, and the measuring tape 20 will pass through the braking structure 60 when it is pulled out or retracts into the storage compartment 121. The braking structure 60 is capable of restrict or release the movement state of the measuring tape 20 therewithin, and the movement state includes prohibiting the measuring tape 20 from moving or allowing the measuring tape 20 to move freely. The braking structure 60 comprises a rotatable roller shaft 61 and a brake shaft 62. The roller shaft 61 and the brake shaft 62 are parallel to each other, and the measuring tape 20 passes between them. When the roller shaft 61 and the brake shaft 62 approach each other and fit closely to each other, the measuring tape 20 is restricted from moving. When the roller shaft 61 and the brake shaft 62 separate from each other and have a sufficient gap, the measuring tape 20 is capable of move freely between them.

As shown in FIGS. 1 to 3, to facilitate the measurement of the circumference of an object to be measured, the tape measure in the present application further comprises a snap-fit assembly 30, which comprises a first fastener 31 and at least one second fastener 32. The first fastener 31 is arranged at a second end of the measuring tape 20 and fixedly connected to the measuring tape 20, and the second fastener 32 is fixedly arranged on the case 10. The first fastener 31 is capable of selectively engage with or separate from one of the second fasteners 32.

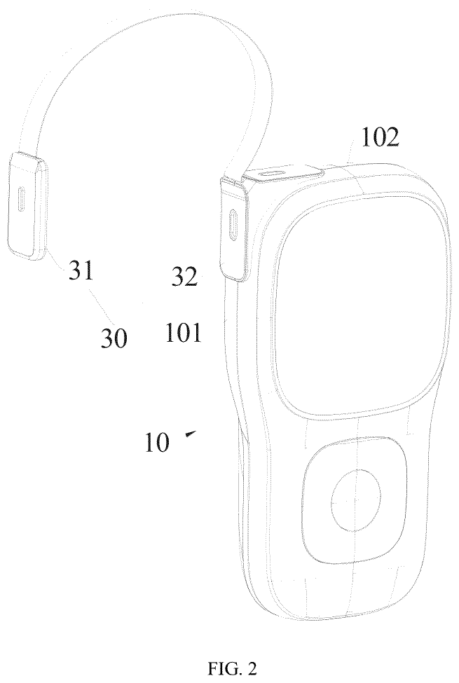

As shown in FIGS. 2 and 3, in some embodiments, the case 10 comprises a first side wall 101 and a second side wall 102 that are arranged to be adjacent to each other, and the opening 122 of the case 10 is arranged at the intersection of the first side wall 101 and the second side wall 102. Two second fasteners 32 are mounted on the case 10, wherein one second fastener 32a is arranged at one end of the first side wall 101, which end is proximal to the opening 122, and the other second fastener 32b is arranged at one end of the second side wall 102, which end is proximal to the opening 122.

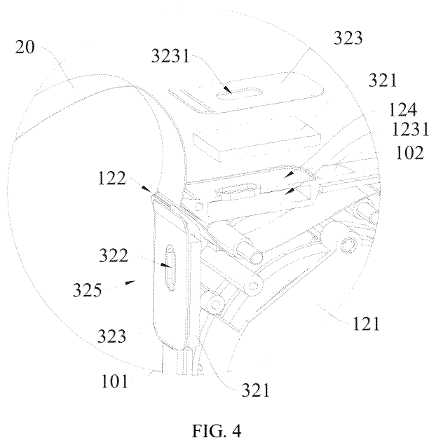

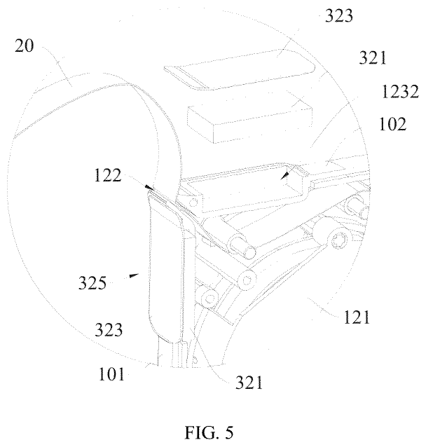

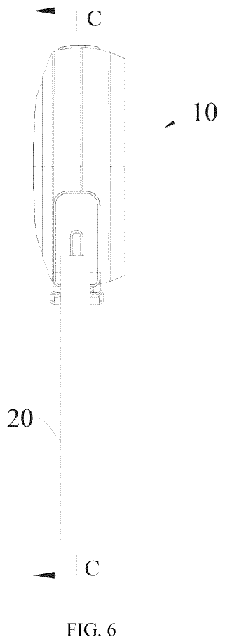

In some embodiments, the second fastener 32 comprises a magnetic sheet 321, which is capable of be made from a permanent magnet material. Taking fixedly mounting the magnetic sheet 321 on the second side wall 102 for example, as shown in FIG. 4, in another embodiment, an accommodating cavity 1231 is arranged at one end of the second side wall 102, which end is proximal to the opening 122, and the magnetic sheet 321 is arranged inside the accommodating cavity 1231. As shown in FIG. 5, in one of the embodiments, an accommodating slot 1232 is arranged at one end of the second side wall 102, which end is proximal to the opening 122, and the magnetic sheet 321 is scarfed in the accommodating slot 1232. The first fastener 31 comprises a case body that is capable of be magnetically attracted, and the case body is made from materials that is capable of be magnetically attracted; alternatively, at least one side of the case body, which side faces the magnetic sheet 321, is made from materials that is capable of be magnetically attracted; alternatively, a component made from materials that is capable of be magnetically attracted is arranged inside the case body. The material that is capable of be magnetically attracted include at least one of iron, cobalt, nickel, and alloys thereof; of course, the material that is capable of be magnetically attracted is capable of also be a permanent magnet material. When the first fastener 31 approaches the second fastener 32, under the action of a magnetic attraction force, the first fastener 31 is capable of be selectively absorbed on the case 10. In other embodiments, the materials of the first fastener 31 and the second fastener 32 is capable of be interchanged to produce them.

The second fastener 32 further comprises a panel 325, which is arranged on an outer side of the case 10, and one end of the panel 325 is located at an edge of the opening 122 of the case 10. In this embodiment, panel 325 is a part of the case 10; of course, the panel 325 is capable of also be arranged as an independent component on the outer side of case 10. When the first fastener 31 approaches the second fastener 32, the first fastener 31 is capable of be absorbed on the panel 325 under the action of a magnetic attraction force. The outer contour of a side of panel 325, which side faces the first fastener 31, and the outer contour of a side of the first fastener 31, which side faces the panel 325, fit in with each other, so that the first fastener 31 fits to the panel 325 more closely.

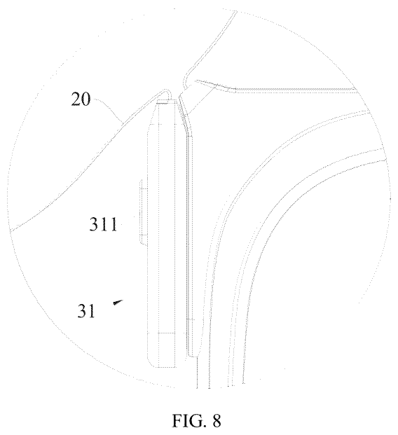

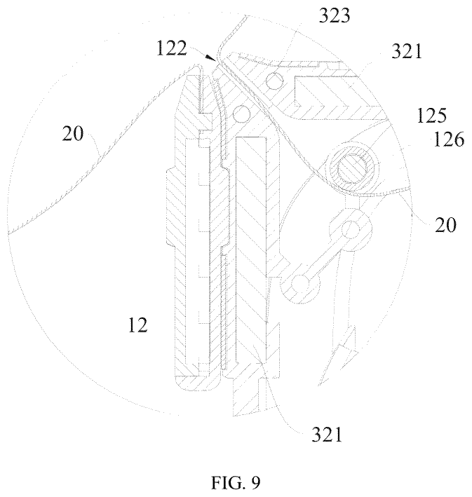

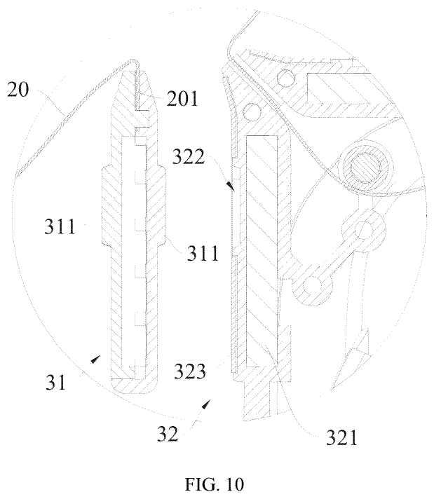

As shown in FIG. 5, in some embodiments, the surface of the panel 325 is smooth, and the position where the first fastener 31 is absorbed on the panel 325 has a certain degree of randomness. During the measurement, the position of the first fastener 31 on the panel 325 may be adjusted for multiple times to meet the measurement conditions. To solve the problem of quickly positioning the first fastener 31 on the panel 325, as shown in FIGS. 5, 8 to 10, in one of the embodiments, a limiting slot 322 that sinks toward the interior of the case 10 is arranged on the panel 325. Correspondingly, a limiting block 311 that protrudes outward is arranged on one side of the first fastener 31, which side faces the second fastener 32. The limiting block 311 fits in with the limiting slot 322, so as to define the position of the first fastener 31 on the panel 325. In another embodiment, a limiting block 311 that protrudes outward the exterior of the case 10 is arranged on the panel 325, and correspondingly, a limiting slot 322 that sinks inward is arranged on one side of the first fastener 31, which side faces the second fastener 32, and the above arrangement is capable of achieve the same limiting effect. Alternatively, in other embodiments, the panel 325 is provided with a slot body that sinks toward the interior of the case 10, and at least a portion of one side of the first fastener 31, which side faces the second fastener 32, is scarfed in the slot body, and the above arrangement is capable of also achieve the same limiting effect.

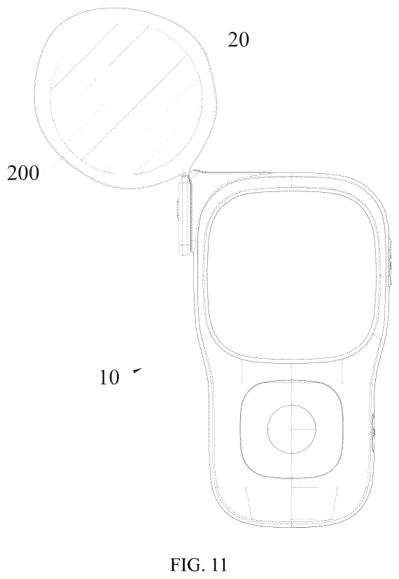

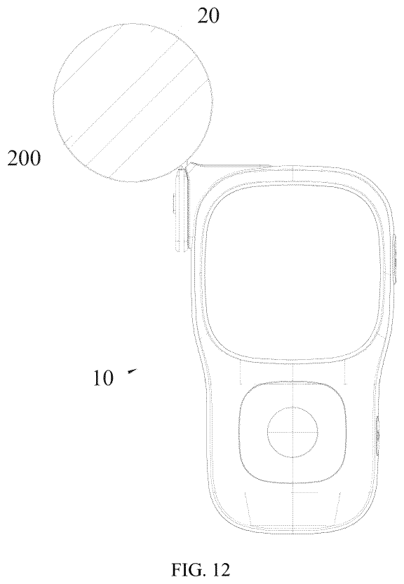

When measuring the circumference of an object 200 to be measured, taking one of measuring methods for example, as shown in FIG. 11, the first fastener 31 is capable of be pulled first and the measuring tape 20 is capable of be pulled out for a sufficient length; then, the pulled length of the measuring tape 20 is capable of be locked through the braking structure 60 of the tape measure; finally, the first fastener 31 is absorbed on the panel 325 after wrapping around the object 200 to be measured once. As shown in FIG. 12, the measuring tape 20 is unlocked by releasing the braking structure 60, and the measuring tape 20 will retract under the drive of the coil spring 40 until the measuring tape 20 is pulled taut. At this point, as the measurement value of the measuring tape 20 is read, the circumference of the object 200 to be measured is capable of be obtained. In the retracting process of the measuring tape 20, since the magnetic attraction force between the first fastener 31 and the second fastener 32 is limited, the first fastener 31 may get detached from the panel 325 when the measuring tape 20 is pulled taut. Alternatively, in the measuring process, the first fastener 31 may get detached from the panel 325 due to improper operation, e.g., dropping the tape measure from hands or applying excessive force when holding the tape measure. To address the problem, in some embodiments, an snap-fit 312 is arranged on one side of the first fastener 31, which side faces the second fastener 32. Correspondingly, the panel 325 is provided with a snap-fit slot 324 that sinks inward, and the snap-fit 312 is capable of be selectively embedded in the snap-fit slot 324 and fastened with the snap-fit slot 324. The first fastener 31 is capable of be restricted on the case 10 through the fit between the snap-fit 312 and the snap-fit slot 324.

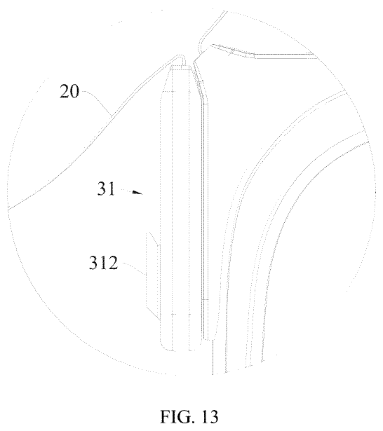

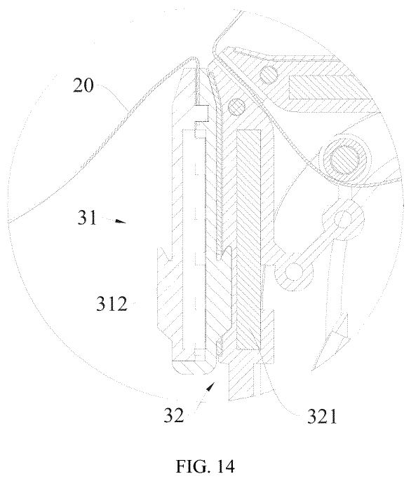

As shown in FIGS. 13 to 15, in some embodiments, the snap-fit 312 comprises a hook portion 3121 that is opened toward the measuring tape 20, and the snap-fit slot 324 comprises a hook slot portion 3241 that extends toward the opening 122 of the case 10. When the snap-fit 312 is engaged with the snap-fit slot 324, the snap-fit 312 is capable of be pushed into the snap-fit slot 324 in a direction that goes along a slot opening of the snap-fit slot 324 and toward both the interior of the snap-fit slot 324 and the opening 122 of the case 10, so that the hook portion 3121 of the snap-fit 312 is completely embedded into the hook slot portion 3241 of the snap-fit slot 324. After the snap-fit 312 is embedded into the snap-fit slot 324, the first fastener 31 is absorbed on the case 10 under the action of a magnetic attraction force, so that the snap-fit 312 is capable of be held in the snap-fit slot 324. During the measurement, the tensile force exerted on the first fastener 31 mainly comes from one side of the measuring tape 20, and the direction of the force exerted on the hook portion 3121 of the snap-fit 312 is limited by the hook slot portion 3241 of the snap-fit slot 324, so that the first fastener 31 cannot get detached from the case 10. When the measurement is completed or the first fastener 31 needs to be removed from the case 10, the first fastener 31 is capable of be removed in a direction opposite to that in the case of scarfing the snap-fit 312 and the snap-fit slot 324 together.

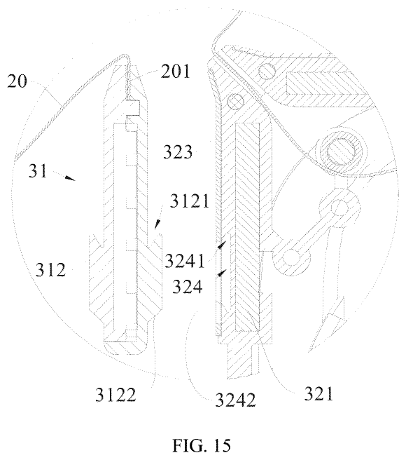

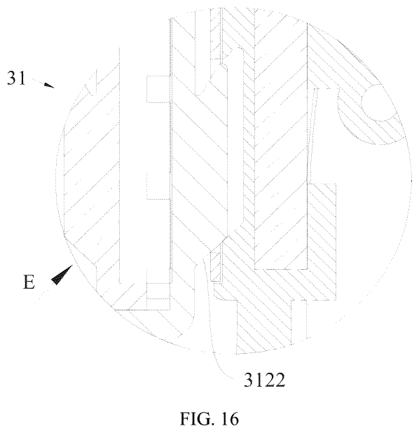

As shown in FIGS. 15 and 16, to quickly embed the hook portion 3121 into the hook slot portion 3241 and facilitate removing the first fastener 31 from the snap-fit slot 324 quickly, in some embodiments, the snap-fit slot 324 is provided with a slope surface 3242, and the slope surface 3242 and the hook slot portion 3241 are arranged at two opposite ends of the snap-fit slot 324. The slope surface 3242 extends in a direction that goes along the slot opening of the snap-fit slot 324 and toward both the interior of the snap-fit slot 324 and the opening 122 of the case 10. Correspondingly, the snap-fit 312 is arranged with a guide surface 3122, the guide surface 3122 and the hook portion 3121 are arranged at two opposite ends of the snap-fit 312, and the guide surface 3122 shares a slope gradient with the slope surface 3242. In the process of inserting the snap-fit 312 into the snap-fit slot 324, the guide surface 3122 and the slope surface 3242 fit to each other and slide in the direction of an arrow E, which is capable of quickly and accurately scarf the snap-fit 312 into the designated position of the snap-fit slot 324, thereby achieving the purpose of quickly mounting and placing the first fastener 31. In the process of removing the snap-fit 312 from the snap-fit slot 324, the first fastener 31 is pushed in the direction away from the opening 122 of the case 10, and under the guidance of the guide surface 3122 and the slope surface 3242, the snap-fit 312 is capable of quickly get detached from the snap-fit slot 324 in the direction opposite to the arrow E, thereby achieving the purpose of quickly removing the first fastener 31.

In addition, as shown in FIGS. 4, 10, and 15, in some embodiments, a patch 323 adheres to the surface of the panel 325. Under the action of a magnetic attraction force, the first fastener 31 may make a sound when it touches the panel 325. The patch 323 is capable of be made from materials with buffering properties, such as silica gel and TPU. The patch 323 is capable of reduce the sound of collision between the first fastener 31 and the panel 325. In addition, the patch 323 is capable of also be made from selected materials with relatively good wear resistance, so as to improve the wear resistance of the panel 325. In addition, if the situation of insufficient light is taken into consideration, the patch 323 is capable of also be made from selected fluorescent materials, so as to improve the visibility of the panel 325. As shown in FIG. 5, in one of the embodiments, the panel 325 is further provided with a groove 124 for accommodating the patch 323, which is restricted therein by the groove 124 to prevent the displacement of the patch 323 on the case 10. As shown in FIG. 4, in one of the embodiments, at least one through hole 3231 is arranged on the patch 323, and the through hole 3231 fits in with the slot opening of the limiting slot 322 or/and the slot opening of the snap-fit slot 324.

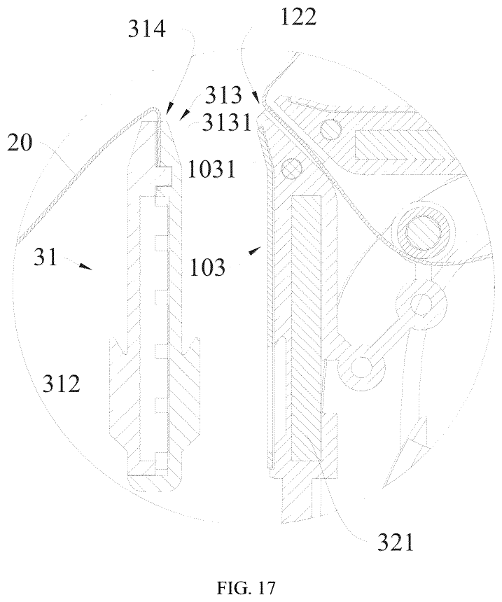

In addition, when measuring the circumference of the object 200 to be measured, the end portion of the measuring tape 20 usually needs to abut against the measuring tape 20 after it is wrapped around the object 200 to be measured once; then, as the scale value at the abutting position on the measuring tape 20 is read, the circumference of the object 200 to be measured is capable of be obtained. As shown in FIGS. 13, 14, and 17, to make the second end of the measuring tape 20 as close to the opening 122 of the case 10 as possible, in some embodiments, a tape opening 314 is arranged at the joint between the first fastener 31 and the measuring tape 20, a chamfering table 313 is arranged at one end of the first fastener 31, which end is proximal to the tape opening 314, a chamfered surface 3131 of the chamfering table 313 is arranged on one side that faces the panel 325, and the tape opening 314 is arranged at the end of the chamfered surface 3131. Correspondingly, the panel 325 is provided with an inclined surface 3251, which is arranged on one side of the panel 325, which side is proximal to the opening 122, the inclined surface 3251 shares an angle of inclination with the chamfered surface 3131, and the opening 122 is arranged at the end of the inclined surface 3251. After the first fastener 31 is absorbed on the panel 325, the chamfered surface 3131 fits to the inclined surface 3251. At this point, the distance between the tape opening 314 and the opening 122 is capable of fall within a negligible range. Alternatively, the error of the measurement value is capable of be limited within a smaller range through length compensation.

In combination with the above embodiments, at least one of the first side wall 101 and the second side wall 102 is provided with the second fasteners 32 as mentioned above, and each second fastener 32 is capable of further be provided with one or more of the limiting slot 322, the snap-fit slot 324, and the patch 323 as mentioned above. The limiting block 311 and/or snap-fit 312 are/is arranged on the two opposite sides of the first fastener 31 correspondingly. Examples include, but are not limited to, the following cases: if both the first side wall 101 and the second side wall 102 are provided with second fasteners 32, and the panel 325 of one of the second fasteners 32 is provided with a limiting slot 322 while the panel 325 of the other second fastener 32 is provided with a snap-fit slot 324, then a limiting block 311 is arranged on a first side of the first fastener 31, and an snap-fit 312 is arranged on a second side thereof; if a limiting slot 322 and a snap-fit slot 324 are provided on the same panel 325, then a limiting block 311 and an snap-fit 312 that correspond thereto are arranged on at least one side of the first fastener 31; if the first side wall 101 or the second side wall 102 is provided with a second fastener 32 and the panel 325 of the second fastener 32 is provided with a limiting slot 322 and/or a snap-fit slot 324, then a limiting block 311 and an snap-fit 312 are arranged on one side of the first fastener 31, which side corresponds thereto.

The above contents only relate to some embodiments of the present application, and are not intended to limit the present application. For those skilled in the art, various modifications and transformations is capable of be made to the present application. Any modifications, equivalent substitutions, improvements among others made within the spirit and principle of the present application shall fall within the scope of protection of the present application.

What is claimed is:

1. A tape measure comprising:
a case (10);
a measuring tape (20), wherein an opening (122) is arranged on the case (10), the measuring tape (20) is capable of being pulled out of the case (10) or retracted within the case (10) through the opening (122), the measuring tape (20) has a first end that is limited to an inner side of the case (10) and a second end that is limited to an outer side of the case (10); and
a snap-fit assembly (30), wherein the snap-fit assembly (30) comprises a first fastener (31) and at least one second fastener (32), the first fastener (31) is fixedly connected to the second end of the measuring tape (20), the at least one second fastener (32) is arranged on the case (10), the first fastener (31) or the at least one second fastener (32) has magnetism, and the first fastener (31) is capable of selectively and magnetically engage with the at least one second fastener (32).

2. The tape measure according to claim 1, wherein the at least one second fastener (32) comprises a panel (325), the panel (325) has one end that is arranged at an edge of the opening (122), and the first fastener (31) is adsorbed on the panel (325) and fit to the panel (325) in response to the first fastener (31) being engaged with the at least one second fastener (32).

3. The tape measure according to claim 2, wherein the at least one second fastener (32) comprises a magnetic sheet (321), the magnetic sheet (321) is arranged on one side of the panel (325), and the side of the panel (325) faces an interior of the case (10).

4. The tape measure according to claim 3, wherein one side of the panel (325 is provided with an accommodating cavity (1231) which faces the interior of the case (10), and the magnetic sheet (321) is arranged within the accommodating cavity (1231), or
the panel (325) is provided with an accommodating slot (1232) that sinks toward the interior of the case (10), and the magnetic sheet (321) is disposed in the accommodating slot (1232).

5. The tape measure according to claim 2, wherein a first limiting member is arranged on one side of the first fastener (31), a second limiting member is arranged on the panel (325), and the first limiting member and the second limiting member is capable of selectively fitting with each other to define a position of the first fastener (31) on the panel (325).

6. The tape measure according to claim 5, wherein the first limiting member comprises a limiting block that protrudes outward, and the second limiting member comprises a limiting slot that sinks inward; or
the first limiting member comprises a limiting slot that sinks inward, and the second limiting member comprises a limiting block that protrudes outward.

7. The tape measure according to claim 2, wherein a first fastening member is arranged on one side of the first fastener (31), a second fastening member is arranged on the panel (325), and the first fastening member and the second fastening member are capable of selectively fitting with each other to limit the detachment of the first fastener (31) from the panel (325).

8. The tape measure according to claim 7, wherein the first fastening member comprises a snap-fit that protrudes outward, and the second fastening member comprises a snap-fit slot that sinks inward; the snap-fit comprises a hook portion that is toward the measuring tape (20), and the snap-fit slot comprises a hook slot portion that extends toward the opening (122); after the snap-fit is engaged with the snap-fit slot, the hook portion of the snap-fit fits in with the hook slot portion of the snap-fit slot; or
the first fastening member comprises a snap-fit slot that sinks inward, and the second fastening member comprises a snap-fit that protrudes outward; the snap-fit slot comprises a hook slot portion that extends away from the measuring tape (20), and the snap-fit comprises a hook portion that is away from the opening (122); after the snap-fit is engaged with the snap-fit slot, the hook portion of the snap-fit and the hook slot portion of the snap-fit slot fit with each other.

9. The tape measure according to claim 8, wherein the snap-fit slot is provided with a slope surface, the slope surface and the hook slot portion are arranged at opposite ends of the snap-fit slot, the slope surface extends along a slot opening of the snap-fit slot toward interiors of the snap-fit slot and the hook slot portion;
the snap-fit is provided with a guide surface, the guide surface and the hook portion are arranged at opposite ends of the snap-fit, and the guide surface shares a slope gradient with the slope surface.

10. The tape measure according to claim 2, wherein a surface of the panel is provided with a patch, the patch is configured to provide buffering when the first fastener (31) is absorbed on the panel (325); or/and emit light to indicate a position of the panel (325).
